(19) United States
(12) Patent Application Publication
(10) Pub. No.: US 2019/0180543 A1
(43) Pub. Date: Jun. 13, 2019

(54) Wireless Biometrics-Based Locking System

(71) Applicants: Stephen Royce Tewkesbury, Hamilton (AU); YIXU MA, St Lucia (AU); HONGYI ZHOU, Shanghai (CN)

(72) Inventors: Stephen Royce Tewkesbury, Hamilton (AU); YIXU MA, St Lucia (AU); HONGYI ZHOU, Shanghai (CN)

(21) Appl. No.: 16/274,811

(22) Filed: Feb. 13, 2019

Related U.S. Application Data
(63) Continuation-in-part of application No. PCT/CN2017/091800, filed on Jul. 5, 2017.

(30) Foreign Application Priority Data
Sep. 23, 2016 (CN) 201621077332.0

(51) Int. Cl. G07C 9/00; G06K 9/00; E05B 47/00

(52) U.S. Cl. CPC G07C 9/00563; G06K 9/00885; G07C 9/00309; G07C 2009/00769; E05B 2047/0094; E05B 2047/0084; E05B 47/0001

(57) ABSTRACT

A wireless biometrics-based locking system has a wireless locking device and a biometric scanning device. The wireless locking device has a locking mechanism, a lock control system, and a secondary wireless communication system. The wireless locking device receives commands through the secondary wireless communication system. These commands are then interpreted by the lock control system and used to transition the locking mechanism between a locked configuration and an unlocked configuration. The biometric scanning device is a computing system capable of capturing a biometric identifier, determining the identity of the user associated to the biometric identifier, and transmitting commands to the wireless locking device. The biometric scanning device has a primary biometric sensor, a scanner control system, and a primary wireless communication system. The sensor captures the biometric identifier, the control system identifies the associated user, and the primary wireless communication system relays an appropriate command to the wireless locking device.

### FIELD OF THE INVENTION

The present invention relates generally to a locking system. More specifically, the present invention relates to a locking system that enables a user to wirelessly unlock a locking device by scanning an appropriate biometric identifier with a biometric scanning device.

### BACKGROUND OF THE INVENTION

Locking systems are invaluable pieces of equipment that enable a use to secure personal property. While useful, traditional locking systems have several drawbacks. Namely, they require the user to remember a code or to carry a key. Both these security measures have flaws. For a code-protected system, the user may forget the code. Similarly, for a keyed-entry system the user may lose the key. Additionally, both security measures are vulnerable to the key or code being stolen by nefarious individuals.

The present invention addresses these shortcomings, among others, of traditional locking systems. To accomplish this, the present invention is a locking system that employs biometric identifiers in lieu of keys and codes. This enables the present invention to function as a keyless entry system for which the user never has to remember a code or carry a key. In addition to keyless entry, the present invention employs a wireless locking mechanism that can be remotely controlled by a biometric identifier capturing device. This enables the user to wirelessly control multiple locking mechanisms from the biometric identifier capturing device.

### BRIEF DESCRIPTION OF THE DRAWINGS

FIG. 1 is a top perspective view of the wireless locking device used in the present invention.

FIG. 2 is a bottom perspective view of the wireless locking device used in the present invention.

FIG. 3 is a front view of the wireless locking device used in the present invention. In this view, the locking mechanism is in a locked configuration.

FIG. 4 is a front view of the wireless locking device used in the present invention. In this view, the locking mechanism is in an unlocked configuration.

FIG. 5 is a front view of the biometric scanning device used in the present invention.

FIG. 6 is a block diagram showing connections between the electrical components of the present invention. In this view, solid arrows indicate electrical connections, while dashed arrows indicate wireless data communication.

FIG. 7 is a block diagram showing the use of the remote server to mediate communication between the wireless locking device and the biometric scanning device. In this view, solid arrows indicate electrical connections, while dashed arrows indicate wireless data communication

FIG. 8 is a system overview showing communication between the biometric scanning device, the remote server, and a plurality of wireless locking devices.

### DETAIL DESCRIPTIONS OF THE INVENTION

All illustrations of the drawings are for the purpose of describing selected versions of the present invention and are not intended to limit the scope of the present invention.

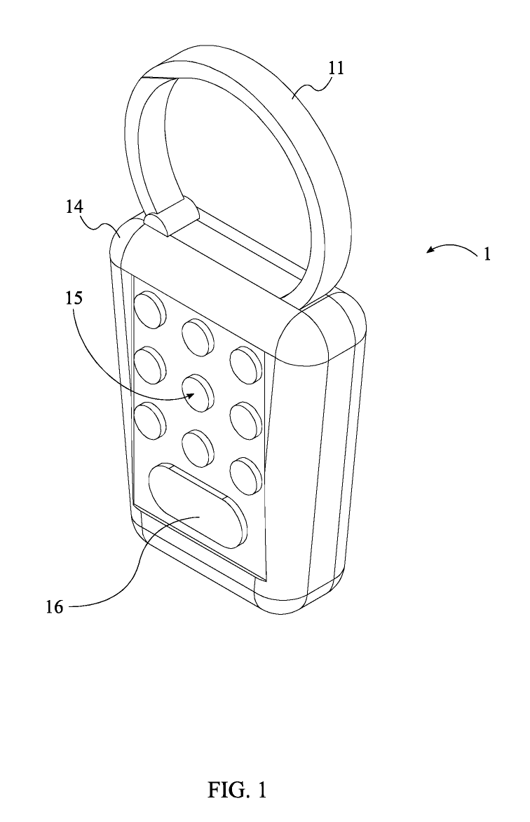

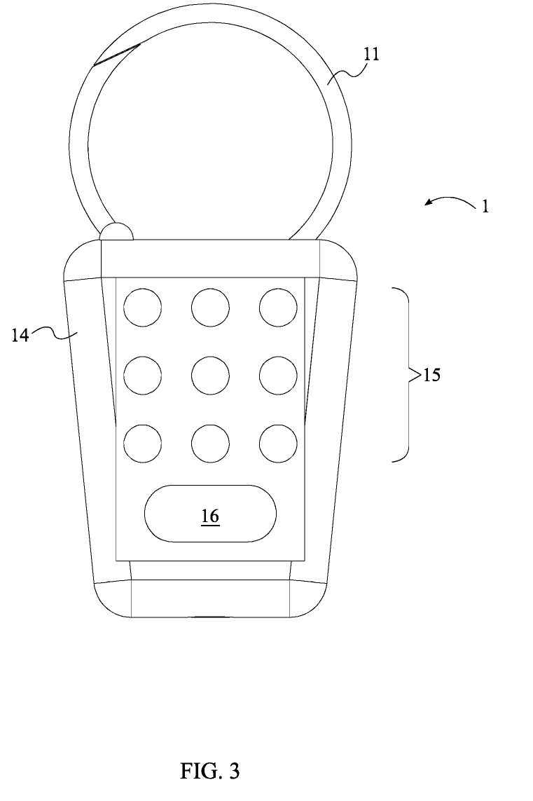

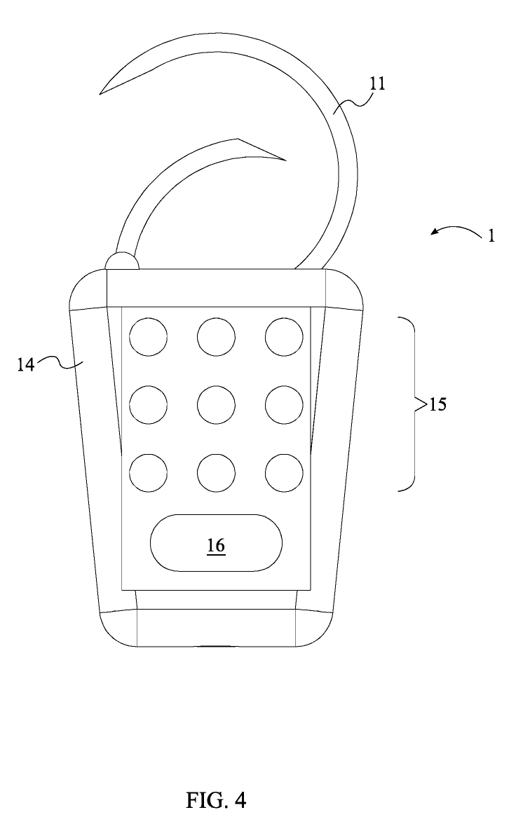

Referring to FIG. 1 through FIG. 8, the present invention is a wireless biometrics-based locking system. This system is designed to enable the use a biometric identifier as a key for engaging or disengaging a remotely situated locking mechanism 11. To achieve this functionality, the present invention comprises at least one locking device 1 and at least one biometric-scanning device. The wireless locking device 1 is a locking mechanism 11 that is capable of wirelessly sending and receiving data. Embodiments of the wireless locking device 1 are designed to function as locks for various systems including, but not limited to, doors, luggage, chests, and vehicles. The biometric-scanning device is an electronic system capable of acquiring the biometric identifier and determining the identity of the individual associated to the biometric identifier. Additionally, the biometric-scanning device is designed to be a computing device capable of wirelessly relaying commands and data between the user and the wireless locking device 1. The biometric scanning device 2 can refer to a variety of devices including, but not limited to, smartphones, security panels, and keyless entry pads for doors.

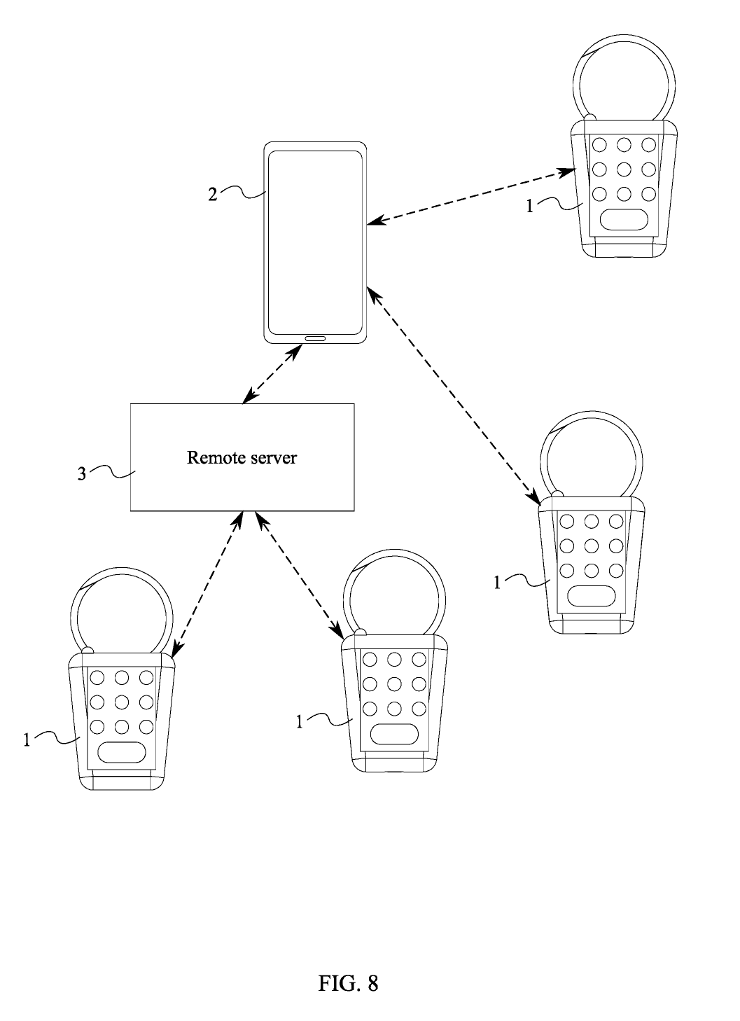

Referring to FIG. 8, to employ the system of the present invention, the user first captures the biometric identifier on with the biometric scanning device 2. Preferably, the biometric identifier is a fingerprint. However, the term biometric identifier can refer to a variety of markers including, but not limited to ocular, facial, and vocal. The biometric scanning device 2 then compares the biometric identifier to a set of stored biometric identifiers to determine the user's identity. If the biometric identifier matches a stored identifier, then the biometric scanning device 2 transmits a command that directs the wireless locking device 1 to become unlocked. Alternatively, the biometric scanning device 2 may give the user an option to unlock a plurality of the wireless locking devices 1. The user is then free to choose the wireless locking devices 1 that should be unlocked while leaving others locked.

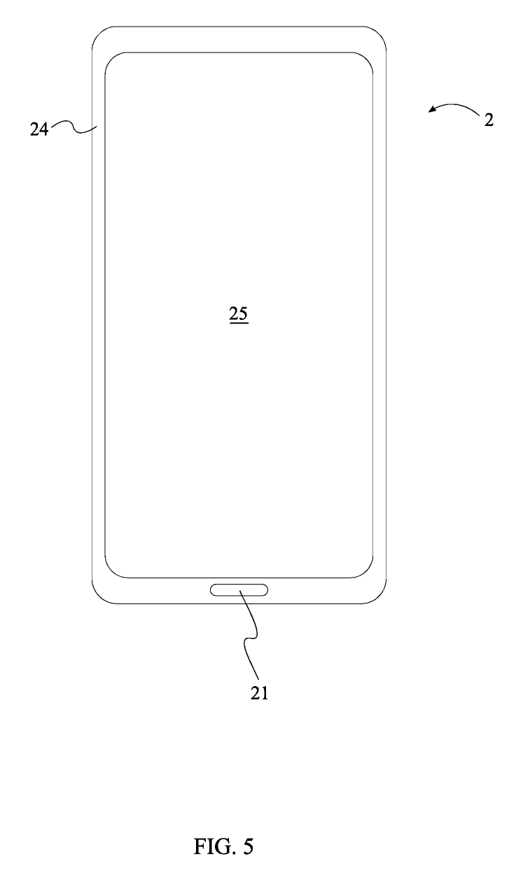

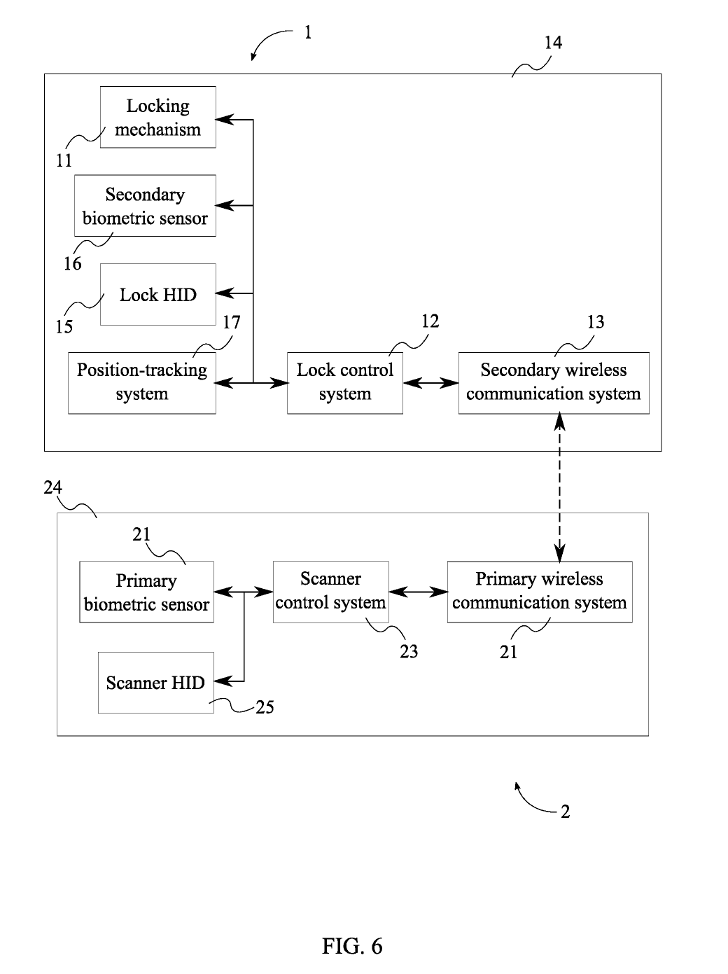

Referring to FIG. 1, FIG. 5, and FIG. 6, to achieve the above-described functionalities, the wireless locking device 1 comprises a locking mechanism 11, a lock control system 12, and a secondary wireless communication system 13. Additionally, the biometric scanning device 2 comprises a primary biometric sensor 21, a primary wireless communication system 22, and a scanner control system 23. The locking mechanism 11 is a mechanically actuated device that can be locked and unlocked upon receipt of an appropriate command. The lock control system 12 is preferably a microcontroller capable of governing the operations of the locking mechanism 11 and the wireless communication system. To that end, the lock control system 12 is electronically connected to the locking device 1 and the secondary wireless communication system 13. Accordingly, the lock control system 12 is used to send and receive data using the secondary wireless communication system 13. Additionally, the lock control system 12 sends commands to the locking mechanism 11 that cause the locking mechanism 11 to transition between a locked configuration and an unlocked configuration.

Referring to FIG. 5 and FIG. 6, the scanner control system 23 is a microcontroller that is integrated into the biometric scanning device 2. The scanner control system 23 is electronically connected to the primary biometric sensor 21 and the primary wireless communication system 22. Consequently, the scanner control system 23 functions similarly to the lock control system 12, in that the scanner control system 23 governs the operations of the electrical components of the biometric scanning device 2. The primary wireless communication system 22 is communicably coupled to the secondary wireless communication system 13. As a result, the biometric scanning device 2 is able to wirelessly issue commands that cause the wireless locking device 1 to transition between the locked configuration and the unlocked configuration. The primary wireless communication system 22 and the secondary wireless communication system 13 are designed to transmit and receive data via wireless communication protocols that include, but are not limited to, Bluetooth, Wi-Fi, GPRS, IR, and ZigBee.

Referring to FIG. 1 and FIG. 6, the wireless locking device 1 is designed to be a tamper-resistant device that remains operable even under extreme conditions. To facilitate this, the wireless locking device 1 further comprises a lock housing. The lock control system 12 and the secondary wireless communication system 13 are mounted within the lock housing. As a result, the lock control system 12 and the secondary wireless communication system 13 are isolated from hazards in the environment that include, but are not limited to, moisture damage, fire damage, and nefarious individuals. Additionally, the locking mechanism 11 is integrated into the lock housing. Accordingly, the locking mechanism 11 and the lock housing form a self-contained unit that is protected from the aforementioned hazards.

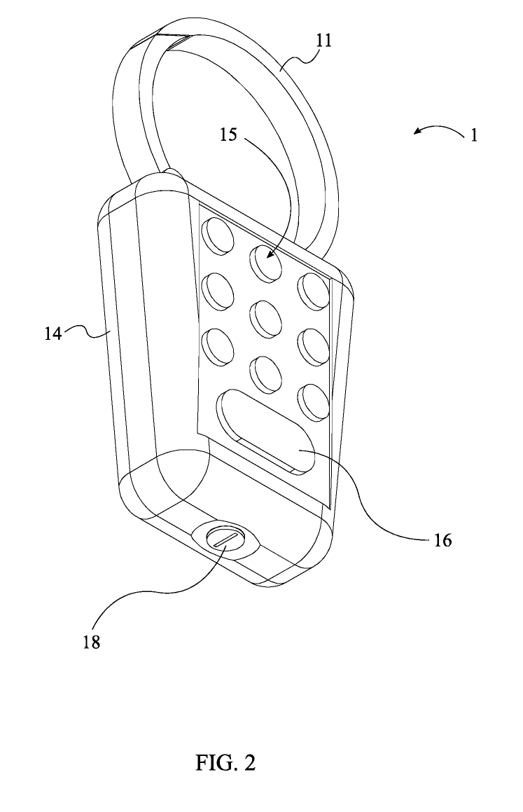

Referring to FIG. 2 and FIG. 6, the present invention expands on the concept of the wireless locking device 1 being a self-contained device by employing components that increase the means by which the user is able to interact with the wireless locking device 1. Specifically, the wireless locking device 1 further comprises a lock human interface device (HID) 15, a secondary biometric sensor 16, a position tracking system, and an emergency keyhole 18. The lock HID 15 is preferably a keypad that enables the user to enter a passcode in lieu of providing a biometric identifier. The lock HID 15 and the secondary biometric sensor 16 are laterally mounted onto the lock housing. Accordingly, the placement of the lock HID 15 and the secondary biometric sensor 16 facilitates manipulation by the user. That is, the lock HID 15 and the secondary biometric sensor 16 are positioned such that the user may input commands or the biometric identifier whether the wireless locking device 1 is in the locked configuration or the unlocked configuration. The lock HID 15 and the secondary biometric sensor 16 are electronically connected to the lock control system 12. As a result, the lock control system 12 is able to interpret the information gathered by the lock HID 15 and the secondary biometric sensor 16. Further, the lock control system 12 governs the operations of the lock HID 15 and the secondary biometric sensor 16. Some embodiments of the wireless locking device 1 are equipped with internal power supplies. These embodiments function as portable locks that can be used in locations where electrical power is not readily available. The position-tracking system 17 is mounted within the lock housing and is electronically connected to the lock control system 12. Consequently, the position-tracking system 17 is able to actively monitor and report the physical location of the wireless locking device 1. The emergency keyhole 18 is integrated the lock housing. Additionally, the emergency keyhole 18 is operatively coupled to the locking mechanism 11, wherein actuating the keyhole causes the locking mechanism 11 to become locked or unlocked. As a result, the user is able to manually transition the locking mechanism 11 between the locked configuration and the unlocked configuration with the use of an appropriate key.

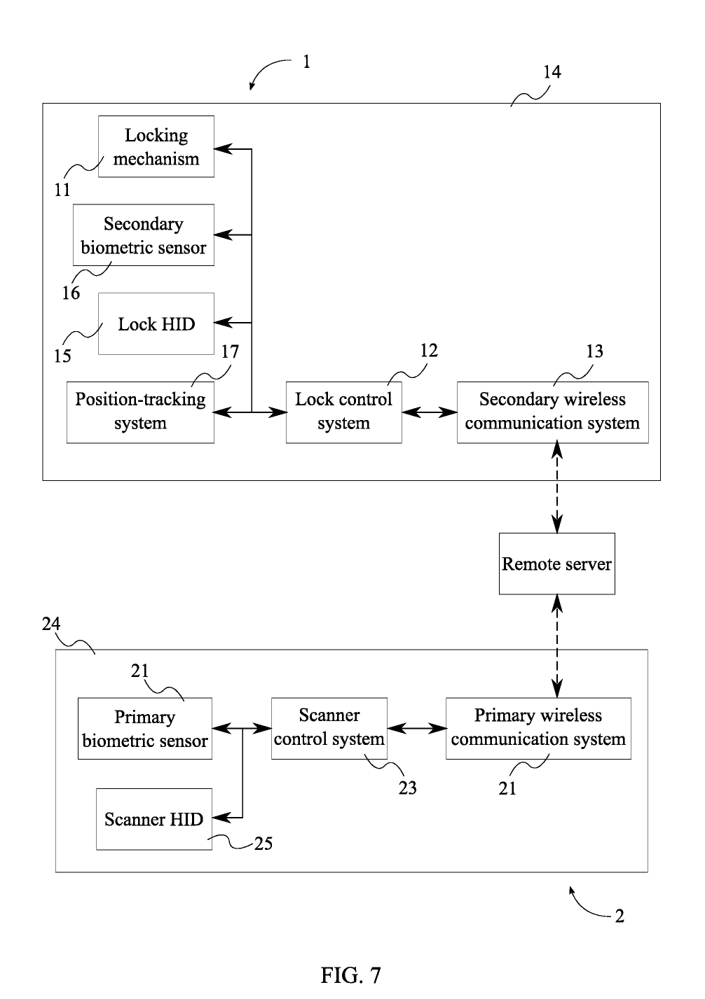

Referring to FIG. 5, FIG. 7, and FIG. 8, the biometric scanning device 2 is preferably a portable handheld device. As such, the biometric scanning device 2 further comprises a scanner housing 24 and a scanner HID 25. The scanner housing 24 is an ergonomic enclosure within which the scanner control system 23 and the primary wireless communication system 22 are mounted. The scanner HID 25 is laterally mounted onto the scanner housing 24 and electronically connected to the scanner control system 23. Consequently, the scanner HID 25 relays information between the user and the scanner control system 23. Preferably, the biometrics scanning device is able to connect to and communicate with the wireless locking device 1 directly. However, some embodiments of the present invention comprise at least one remote server 3. The remote server 3 is used to facilitate transferring data between the wireless locking device 1, the biometric scanning device 2, and any number of external users. Moreover, the remote server 3 is used to execute a number of internal processes for the present invention and is used to store user information, as well as, security protocols, and biometric identifiers. In these embodiments, the remote server 3 mediates the connection between the biometric scanning device 2 and the wireless locking device 1. This connection scheme enables the biometric scanning device 2 to control the wireless locking device 1 even when the wireless locking device 1 is outside the communication range of the primary wireless communication system 22.

Although the invention has been explained in relation to its preferred embodiment, it is to be understood that many other possible modifications and variations can be made without departing from the spirit and scope of the invention as hereinafter claimed.

What is claimed is:

1. A wireless biometrics-based locking system comprising:
at least one wireless locking device;
at least one biometric scanning device;
the wireless locking device comprising a locking mechanism, a lock control system, and a secondary wireless communication system;
the biometric scanning device comprising a primary biometric sensor, a primary wireless communication system, and a scanner control system;
the lock control system being electronically connected to the locking device and the secondary wireless communication system;
the scanner control system being electronically connected to the primary biometric sensor and the primary wireless communication system; and,
the primary wireless communication system being communicably coupled to the secondary wireless communication system.

2. The wireless biometrics-based locking system as claimed in claim 1 comprising:
the wireless locking mechanism further comprising a lock housing;
the lock control system and the secondary wireless communication system being mounted within the lock housing; and,
the locking mechanism being integrated into the lock housing.

3. The wireless biometrics-based locking system as claimed in claim 2 comprising:
the wireless locking mechanism further comprising a lock human interface device (HID);
the lock HID being laterally mounted onto the lock housing; and,
the lock HID being electronically connected to the lock control system.

4. The wireless biometrics-based locking system as claimed in claim 2 comprising:
the wireless locking mechanism further comprising a secondary biometric sensor;
the secondary biometric sensor being laterally mounted onto the lock housing; and,
the secondary biometric sensor being electronically connected to the lock control system.

5. The wireless biometrics-based locking system as claimed in claim 2 comprising:
the wireless locking mechanism further comprising a position-tracking system;
the position-tracking system being mounted within the lock housing; and,
the position-tracking system being electronically connected to the lock control system.

6. The wireless biometrics-based locking system as claimed in claim 2 comprising:
the wireless locking mechanism further comprising an emergency keyhole;
the emergency keyhole being integrated the lock housing; and,
the emergency keyhole being operatively coupled to the locking mechanism, wherein actuating the keyhole causes the locking mechanism to become locked or unlocked.

7. wireless biometrics-based locking system as claimed in claim 1 comprising:
the biometric scanning device further comprising a scanner housing; and,
the scanner control system and the primary wireless communication system being mounted within the scanner housing.

8. wireless biometrics-based locking system as claimed in claim 7 comprising:
the biometric scanning device further comprising a scanner HID;
the scanner HID being laterally mounted onto the scanner housing; and,
the scanner HID being electronically connected to the scanner control system.

9. wireless biometrics-based locking system as claimed in claim 7 comprising:
at least one remote server; and,
the biometric scanning device and the wireless locking device being communicably coupled to the remote se4rver.
